(19) United States
(12) Patent Application Publication
(10) Pub. No.: US 2024/0024795 A1
(43) Pub. Date: Jan. 25, 2024

(54) TOY SPLICING METHOD AND BEAD BOARD

(71) Applicants: Jinkun Li, Jieyang City (CN); Guangzhou Jinzhong Network Technology Co., Ltd., Guangzhou (CN)

(72) Inventor: Jinkun Li, Jieyang City (CN)

(21) Appl. No.: 17/902,634

(22) Filed: Sep. 2, 2022

(30) Foreign Application Priority Data
Jul. 25, 2022 (CN) 202221950463.0

(51) Int. Cl. A63H 33/00; B44C 3/12; A63H 33/08

(52) U.S. Cl. CPC A63H 33/001; B44C 3/12; A63H 33/08

(57) ABSTRACT

The present invention discloses a toy splicing method and a bead board, the method comprises the following steps: step 1, providing positioning columns on a bead board, orderly arranging a plurality of positioning columns on a motherboard in a vertical and a horizontal direction, and placing fuse beads on the positioning columns of the bead board to form a splicing pattern; step 2, pasting an ironing paper on the splicing pattern; step 3, preheating the heating device; step 4, placing the heating device on the ironing paper to iron the splicing pattern; step 5, heating and melting the surfaces of the fuse beads at high temperature of an iron until the surfaces are mutually adhered; and step 6, cooling the mutually adhered fuse beads, and separating the splicing pattern from the bead board. As compared with the prior art, the toy splicing method and the bead board of the present invention can exert a child's own imagination for free splicing, which can not only exercise the child's own hands-on ability, but also cultivate the child's spatial imagination ability and fine hands-on ability.

### TECHNICAL FIELD OF THE DISCLOSURE

The present disclosure involves the technical field of toys, specifically a toy splicing method and a bead board.

### BACKGROUND OF THE DISCLOSURE

Toys are products for human, especially children, to have fun and play. Specifically, the children's toys can be classified into the following ten types:

Splicing toys aimed to improve cognitive ability, analysis ability and imagination of children and cultivate the sense of achievement of children.

Game toys aimed to cultivate the children's ability of practice and thought on the basis of improving the cognitive ability of children, and develop their thinking, exercise operation skills and hand-eye coordination.

Number, abacus, and wordplay toys aimed to when training children's inlaying ability, exercise of large movement, train children's fine movements, inspire children's accurate understanding of shapes, numbers, and quantities, and then exercise muscle flexibility.

Tool toys aimed to mainly let children understand and master shapes, colours and structures of various tools, in the process of training children's practical hands-on ability and hand-eye coordination ability, and develop imagination.

Intellective combination toys aimed to develop spatial imagination ability and fine hands-on ability of children, so as to deepen the rational understanding of time, animals, vehicles, the shape of houses and colours.

Building blocks aimed to arouse the practical interest of children, cultivate children's awareness of reasonable combination and matching and spatial imagination ability; the ingenious dragging design can exercise the walking ability of children and encourage the sense of achievement in creation of children.

Traffic toys aimed to train assembling, dragging and organizing skills of the children on the basis of improving the cognition and understanding of children on the structure of trains, automobiles and various engineering vehicles, improve the hands awareness and the self-care ability of daily living, and know the conversion relationship among objects by splicing and building.

Dragging toys aimed to improve cognitive ability of children, and train walking ability of children in a large range by knowing different characteristics of various animals according to different dragging animals

Jigsaw toys composed of various jigsaws with different shapes and rich contents. These toys aimed to exercise independent thinking capability and simultaneously cultivate the patience and the constant spirit of children on the basis that children have certain cognition on the combination, the split and the recombination of the patterns.

Cartoon dolls: when the parents are busy, some entertainment toys capable of accompanying children are needed, and cartoon dolls with lovely shapes are popular among children.

At present, there is no toy that can integrate multiple toy functions, exert a child's own imagination for splicing, which can not only exercise the child's own hands-on ability, but also cultivate the child's spatial imagination ability and fine hands-on ability.

### SUMMARY OF THE DISCLOSURE

The present disclosure provides a toy splicing method, which can exert a child's own imagination for free splicing, and not only exercise the child's own hands-on ability, but also cultivate the child's spatial imagination ability and fine hands-on ability.

In order to realize the purpose of the present disclosure, the present disclosure provides the following technical solutions:

Toy splicing method, comprising the following steps:

step 1, providing positioning columns on a bead board, orderly arranging a plurality of positioning columns on a motherboard in a vertical and a horizontal direction, and placing fuse beads on the positioning columns of the bead board to form a splicing pattern;

step 2, pasting an ironing paper on the splicing pattern;

step 3, preheating the heating device;

step 4, placing the heating device on the ironing paper to iron the splicing pattern;

step 5, heating and melting the surfaces of the fuse beads at high temperature of an iron until they are mutually adhered;

step 6, cooling the mutually adhered fuse beads, and separating the splicing pattern from the bead board.

Preferably, the toy splicing method further comprises step 7, pasting the ironing paper on the other side of the splicing pattern.

Preferably, the toy splicing method further comprises step 8, placing the heating device on the ironing paper to iron the splicing pattern back and forth.

Preferably, the toy splicing method further comprises step 9, heating and melting the surfaces of the fuse beads at high temperature of an iron until they are mutually adhered.

Preferably, the toy splicing method further comprises step 10, cooling forming the mutually adhered fuse beads.

Preferably, in step 3, preheating the heating device for 1 to 5 minutes.

Preferably, in step 4, placing the heating device on the ironing paper to iron the splicing pattern.

Preferably, in step 6, pressing a weight on the mutually adhered fuse beads to cool, so as to flatten them after cooling.

Preferably, the fuse bead is a fusion bean, and a groove or a through hole is arranged in the fusion bean.

Preferably, the heating device is an iron.

In addition, the present disclosure further discloses a bead board, comprising a motherboard and a plurality of positioning columns, wherein

the positioning columns are arranged on the motherboard and are orderly arranged on the motherboard in a vertical and a horizontal direction;

the positioning columns are cones, and the tip of the positioning column has circular arc shape;

the bottom edge of motherboard is provided with protruding edges, the protruding edges are provided with tenons and engagement grooves, the tenons and the engagement grooves are arranged on the opposing edges respectively, and the engagement grooves are formed by hollowing out the protruding edges.

Preferably, the bottom of the motherboard is provided with a raised rib (i.e. stiffener) having a convex height corresponding to the height of the protruding edge.

Preferably, the rib is circular ring-shaped or X-shaped.

Preferably, the positioning columns and the motherboard are integrally formed.

As compared with the prior art, the present disclosure provides a toy splicing method. The toy splicing method can exert a child's own imagination for free splicing, which can not only exercise the child's own hands-on ability, but also cultivate the child's spatial imagination ability and fine hands-on ability.

As compared with the prior art, the present disclosure provides a bead board, which is provided with positioning columns, the fuse beads are limited on the fixed position of the motherboard by the positioning columns, thus shortening the jigsaw time and making the finished product shape more stable; the positioning columns are cones whose volumes increase from top to bottom to avoid the fuse beads being stuck on the positioning columns and unable to be removed; the tip of the positioning column has circular arc shape so as to prevent scratching a user; the motherboards can be spliced together through the tenons and the engagement grooves, thereby expanding the spliceable area.

### BRIEF DESCRIPTION OF THE DRAWINGS

FIG. 1 is a perspective view of a splicing device, wherein Part a is a assembly drawing of a fuse bead and a positioning element, according to an embodiment of present disclosure;

FIG. 2 is an enlarged view of the Part a in FIG. 1.

FIG. 3 is a frontal structural view of the bead board with positioning columns according to an embodiment of the present disclosure;

FIG. 4 is a rear structural view of the bead board with positioning columns according to an embodiment of the present disclosure.

FIG. 5 is an overall schematic view of fusion beans according to an embodiment of the present disclosure.

### DETAILED DESCRIPTION OF THE PREFERRED EMBODIMENT

The technical solutions of the embodiments of the present disclosure will be clearly and entirely described below with the drawings of the embodiments of the present disclosure. Obviously, the described embodiments are just a part of the embodiments of the present disclosure, and are not all of them. All other embodiments that can be obtained by a person skilled in the art based on the embodiments of the present disclosure without any creative effort are included in the protection scope of the present disclosure.

It should be noted that, all the directional indications (such as up, down, left, right, front, rear . . . ) in the embodiments of the present disclosure are merely used for explaining the relative positional relationship and movement conditions and the like between each part under a certain posture (as shown in the drawings), if such a posture changes, then the directional indications are changed correspondingly.

In the present disclosure, such description involving “first” and “second” and the like are merely for the purpose of description, but cannot be understood as indicating or implying its relative importance or implicitly indicating the quantity of the indicated technical features. Therefore, the feature defined with “first” and “second” can explicitly or implicitly include at least one such feature; secondly, in the description of the present disclosure, “a plurality of” means at least two, for example, two, three and the like, unless otherwise specifically defined.

In the present disclosure, unless otherwise definitely prescribed and defined, the terms “connection”, “connected”, “fixed” and the like should be understood in its broad sense. For example, the “connection” may be a fixed connection, may also be a detachable connection or an integrated connection; may be a mechanical connection, may also be an electrical connection; and the “connected” may be directly connected and can also be indirectly connected through an intermediate medium, and can also be the internal communication inside two elements or an interaction relationship between two elements, unless otherwise definitely defined. The specific meaning of the above-mentioned terms in the present disclosure may be understood by those of ordinary skill in the art in light of specific circumstances.

In addition, the technical solutions between each embodiment in the present disclosure can be mutually combined, but should be on the basis that the technical solutions can be realized by those skilled in the art, when the combination of the technical solutions is contradictory or cannot be realized, it should be deemed that the combination of technical solutions does not exist and does not fall within the protection scope claimed by the present disclosure.

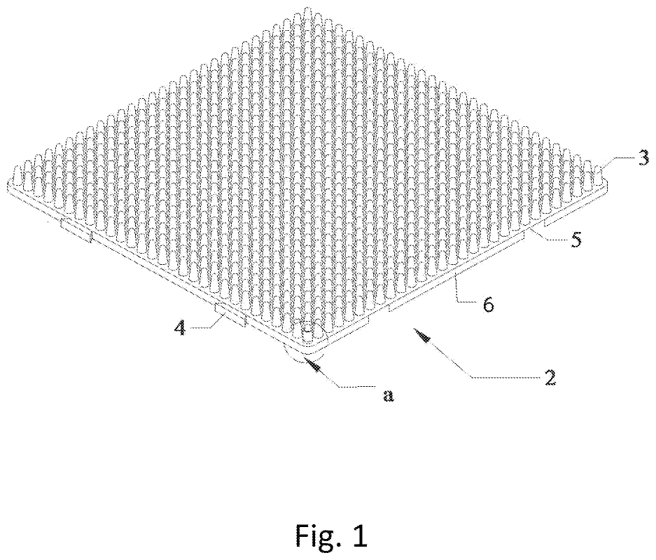

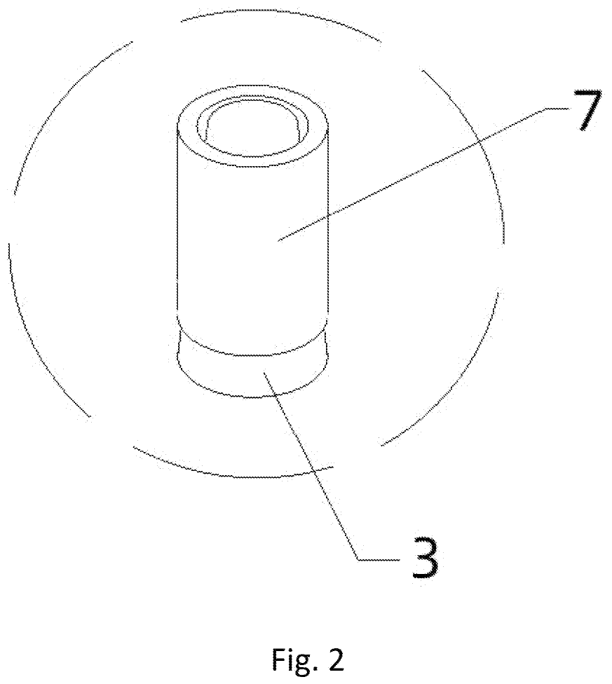

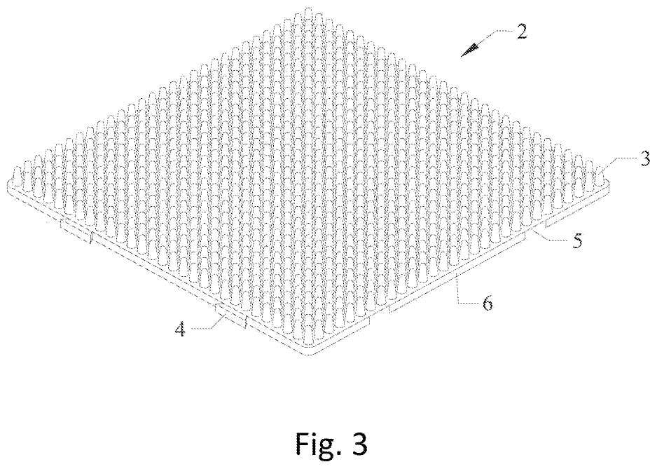

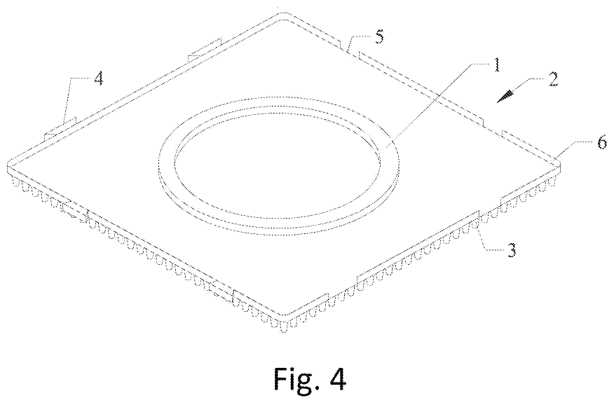

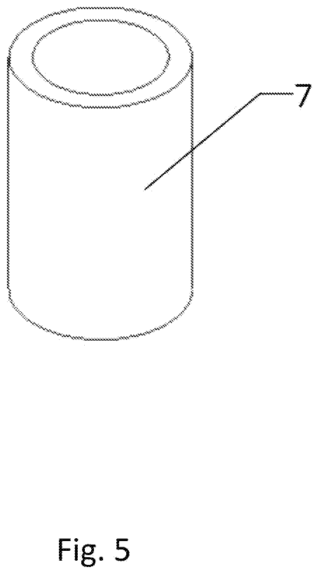

Referring to FIGS. 1 to 5, FIG. 1 is a perspective view of the splicing device, wherein the part a is a assembly drawing of a fuse bead and a positioning element; FIG. 2 is an enlarged view of the Part a; FIG. 3 is a frontal structural view of the bead board with positioning columns in the embodiment of the present disclosure; FIG. 4 is a rear structural view of the bead board with positioning columns in the embodiment of the present disclosure; FIG. 5 is an overall schematic view of the fusion beans in the embodiment of the present disclosure.

Reference signs in the drawings: rib 1, motherboard 2, positioning column 3, tenon 4, engagement groove 5, protruding edge 6, fusion bean 7.

The present disclosure provides a bead board with positioning columns, which comprises a motherboard 2 and a plurality of positioning columns The positioning columns 3 are arranged on the motherboard 2, the positioning columns 3 are orderly arranged on the motherboard 2 in a vertical and a horizontal direction; the positioning columns 3 are cones, and the tip of the positioning column 3 has circular arc shape; the bottom edge of motherboard 2 is provided with protruding edges 6, the protruding edges 6 are provided with tenons 4 and engagement grooves 5, the tenons 4 and the engagement grooves 5 are arranged on the opposing edges respectively, and the engagement grooves are formed by hollowing out the protruding edges 6.

The present disclosure provides a bead board with positioning columns, which is provided with positioning columns 3, the fuse beads are limited on the fixed position of the motherboard 2 by the positioning columns 3, thus shortening the jigsaw time and making the finished product shape more stable; the positioning columns 3 are cones whose volumes increase from top to bottom to avoid the fuse beads being stuck on the positioning columns 3 and unable to be removed; the tip of the positioning column 3 has circular arc shape so as to prevent scratching a user; the tenons 4 are of an inverted trapezoidal structure on the protruding edge 6; a plurality of motherboards can be spliced together through the tenons and the engagement grooves, thereby expanding the spliceable area.

In addition, in the first aspect, the motherboard 2 is polygonal structure, and the middle position of the bottom of the motherboard 2 is provides with a raised rib 1 having a convex height corresponding to the height of the protruding edge 6, and the rib 1 is circular ring-shaped, thereby reducing the material used for the motherboard 2 and enhancing the pressure bearing capacity of the motherboard 2. The rib is X-shaped, which can also have the same effect, and will not be repeated here.

In the second aspect, the positioning columns 3 and the motherboard 2 are integrally formed. The connection with the motherboard 2 is firm and not easy to fall off.

As compared with the prior art, the present disclosure provides a bead board, which is provided with positioning columns, the fuse beads are limited on the fixed position of the motherboard by the positioning columns, thus shortening the jigsaw time and making the finished product shape more stable; the positioning columns are cones whose volumes increase from top to bottom to avoid the fuse beads being stuck on the positioning columns and unable to be removed; the tip of the positioning column has circular arc shape so as to prevent scratching a user; the motherboards can be spliced together through the tenons and the engagement grooves, thereby expanding the spliceable area.

### First Embodiment

A toy splicing method in the present embodiment comprises the following steps:

step 1, providing positioning columns on a bead board, orderly arranging a plurality of positioning columns on a motherboard in a vertical and a horizontal direction, and placing fuse beads on the positioning columns of the bead board to form a splicing pattern;

step 2, pasting an ironing paper on the splicing pattern;

step 3, preheating the heating device for 3 minutes;

step 4, placing the heating device on the ironing paper to iron the splicing pattern for 2 minutes;

step 5, heating and melting the surfaces of the fuse beads at high temperature of an iron until they are mutually adhered;

step 6, cooling the mutually adhered fuse beads, and separating the splicing pattern from the bead board.

Preferably, in step 6, pressing a weight on the mutually adhered fuse beads to cool, so as to flatten them after cooling.

Preferably, the fuse bead is a fusion bean 7, and a groove or a through hole is arranged in the fusion bean 7.

Preferably, the heating device is an iron.

In this embodiment, only one side of the splicing pattern is ironed, and the other side is not ironed. During ironing, each ironing paper is reusable.

As compared with the prior art, the present disclosure provides a toy splicing method. The toy splicing method can exert a child's own imagination for free splicing, which can not only exercise the child's own hands-on ability, but also cultivate the child's spatial imagination ability and fine hands-on ability.

### Second Embodiment

A toy splicing method in the present embodiment comprises the following steps:

step 1, providing positioning columns on a bead board, orderly arranging a plurality of positioning columns on a motherboard in a vertical and a horizontal direction, and placing fuse beads on the positioning columns of the bead board to form a splicing pattern;

step 2, pasting an ironing paper on the splicing pattern;

step 3, preheating the heating device for 3 minutes;

step 4, placing the heating device on the ironing paper to iron the splicing pattern for 3 minutes;

step 5, heating and melting the surfaces of the fuse beads at high temperature of an iron until they are mutually adhered;

step 6, cooling the mutually adhered fuse beads, and separating the splicing pattern from the bead board;

step 7, pasting an ironing paper on the other side of the splicing pattern;

step 8, placing the heating device on the ironing paper to iron the splicing pattern back and forth;

step 9, heating and melting the surfaces of the fuse beads at high temperature of an iron until the surfaces of them are mutually adhered.

step 10, cooling forming the mutually adhered fuse beads.

Preferably, in step 6, pressing a weight on the mutually adhered fuse beads to cool, so as to flatten them after cooling.

Preferably, the fuse bead is a fusion bean 7, and a groove or a through hole is arranged in the fusion bean 7.

Preferably, the heating device is an iron.

In this embodiment, if only one side of the splicing pattern is ironed to make it look unsightly on the other side, or if it is desired that the splicing pattern be very firm, then it is possible to iron on both sides.

During ironing, each ironing paper is reusable.

As compared with the prior art, the present disclosure provides a toy splicing method. The toy splicing method can exert a child's own imagination for free splicing, which can not only exercise the child's own hands-on ability, but also cultivate the child's spatial imagination ability and fine hands-on ability.

The above description of the disclosed embodiments enables a person skilled in the art to carry out or use the present disclosure. Various modifications to these embodiments will be obvious for a person skilled in the art. The general principles defined in the present text can be realized in other embodiments as long as they do not deviate from the concept or scope of the present disclosure. Therefore, the present disclosure is not limited to the aforesaid embodiments shown in the present text, and it covers a broadest scope in which any embodiment will be included as long as its principles and novel features are consistent with those disclosed by the present text.

1. A toy splicing method, characterized by comprising the following steps:
step 1, a bead board comprising a motherboard and a plurality of positioning columns, the positioning columns orderly arranged on the motherboard of the bead board in a vertical and a horizontal direction, and placing fuse beads on the positioning columns of the bead board to form a splicing pattern;
step 2, pasting an ironing paper on the splicing pattern;
step 3, preheating a heating device;
step 4, placing the heating device on the ironing paper to iron the splicing pattern;
step 5, heating and melting the surfaces of the fuse beads at high temperature of the heating device until they are mutually adhered;
step 6, pressing a weight on the mutually adhered fuse beads and cooling the mutually adhered fuse beads to make them flat after cooling, and then separating the splicing pattern from the bead board.

2. The toy splicing method according to claim 1, characterized by further comprising step 7, pasting the ironing paper on the other side of the splicing pattern.

3. The toy splicing method according to claim 2, characterized by further comprising step 8, placing the heating device on the ironing paper to iron the splicing pattern back and forth.

4. The toy splicing method according to claim 3, characterized by further comprising step 9, heating and melting the surfaces of the fuse beads at high temperature of the heating device until they are mutually adhered.

5. The toy splicing method according to claim 4, characterized by further comprising step 10, cooling forming the mutually adhered fuse beads.

6. The toy splicing method according to claim 1, characterized in that, in step 3, preheating the heating device for 1 to 5 minutes.

7. The toy splicing method according to claim 1, characterized in that, in step 4, placing the heating device on the ironing paper to iron the splicing pattern back and forth for 1 to 5 minutes.

8. (canceled)

9. The toy splicing method according to claim 1, characterized in that the fuse bead is a fusion bean, and a groove or a through hole is arranged in the fusion bean.

10. The toy splicing method according to claim 1, characterized in that the heating device is an iron.

11. A bead board, characterized in that it comprises a motherboard and a plurality of positioning columns, wherein
the positioning columns are arranged on the motherboard and are orderly arranged on the motherboard in a vertical and a horizontal direction;
the positioning columns are cones, and the tip of the positioning column has circular arc shape;
the bottom edge of motherboard is provided with protruding edges, the protruding edges are provided with tenons and engagement grooves, the tenons and the engagement grooves are arranged on the opposing edges respectively, and the engagement grooves are formed by hollowing out the protruding edges.

12. The bead board according to claim 11, characterized in that the bottom of the motherboard is provided with a raised rib having a convex height corresponding to the height of the protruding edge.

13. The bead board according to claim 12, characterized in that the rib is circular ring-shaped or X-shaped.

14. The bead board according to claim 11, characterized in that the positioning columns and the motherboard are integrally formed.
